(19) United States
(12) Patent Application Publication
(10) Pub. No.: US 2003/0182424 A1
(43) Pub. Date: Sep. 25, 2003

(54) Scriptable proxy server

(76) Inventor: Steve Odendahl, Stonington, CT (US)

Correspondence Address: Robert C. Kowert, Conley, Rose & Tayon, P.C., P.O. Box 398, Austin, TX, 78767, US

(21) Appl. No.: 10/134,720

(22) Filed: Apr. 29, 2002

Related U.S. Application Data
(60) Provisional application No. 60/366,940, filed on Mar. 22, 2002.

(51) Int. Cl. G06F 15/16; G06F 15/173

(52) U.S. Cl. 709/225; 709/203

(57) ABSTRACT

A proxy server may receive a script request from a client indicating a script including a sequence of server requests for a server. The proxy server may send the sequence of server requests to the server. In one embodiment, the proxy server may traverse a series of content pages provided by the server in response to the sequence of server requests. The series of content pages may culminate in an endpoint page. The proxy server may provide the endpoint page to the client. The client may interact from the endpoint page with the one or more servers. In one embodiment, the script may automate the traversal of a series of content pages for the user. Thus, the proxy server may save the user resources (e.g. time) used in a manual traversal of the series of content pages.

This application claims benefit of priority to U.S. Provisional Application No. 60/366,940, filed Mar. 22, 2002.

### BACKGROUND OF THE INVENTION

1. Field of the Invention

This invention relates to networked environments, and more particularly to a mechanism for automating content or page traversal using a proxy server in a client-server environment.

2. Description of the Related Art

Web applications may provide a hierarchy of content (e.g. web pages) to one or more clients. Web application development and testing often involves the developer or tester traversing a series of pages of content before arriving at the page to be tested. For example, to reach a destination page in the desired state, the tester may need to traverse a series or sequence of pages or content interacting with some or all of the pages/content. Such a series of pages may include, for example, a welcome page, login page, portal page, search page, etc. Each change to a web application may require the tester to re-traverse the series of pages of content. For example, a web developer may edit a Java servlet, compile the servlet, and restart the servlet engine. The tester may have to traverse a login page, a portal page, an advanced query page, and multiple pages of results from an advanced query to test the changes. Testing may require traversing a set of pages a plurality of times. Traversing the pages manually for every change may consume development time and testing resources.

Web developers may automate the traversal of pages by using web testing frameworks. Web testing frameworks may use scripts to traverse user interfaces of web applications. Web testing frameworks may compare the script output with a benchmark output to check validity of the output. However, current web testing frameworks do not allow the tester to interact with the output to continue interaction with the application from that point forward. Also, such web testing frameworks do provide access to the web application through a client (e.g. a browser), which may limit the ability to test the application.

Users who frequent a particular web site must also often traverse a complex or tedious set of pages or steps to navigate to a desired page or content. Each time the user returns to the web site, the complex or tedious sequence must be traversed again to reach the desired endpoint.

### SUMMARY OF THE INVENTION

A client-server application may include one or more servers and one or more clients. In one embodiment, the servers may be HTTP (Hyper Text Transport Protocol) servers. In one embodiment, the one or more clients may include one or more web browsers and the one or more servers may include one or more web servers. In one embodiment, a proxy server may be included that is configured to receive script requests from clients. A script request may indicate a script including a sequence of server requests for one or more of the servers. In one embodiment, the sequence of server requests may include HTTP requests. In one embodiment, the indicated script may include one or more lines of code of an interpreted language (e.g. Perl or Python). In one embodiment, a developer may write scripts for testing a web application. In one embodiment, scripts may be used to automate traversal of a web site for a user. For example, the user may frequently and/or periodically desire to traverse to a destination web site, and a proxy server may execute a script to transparently traverse one or more intermediate web sites to reach the destination web site.

In one embodiment, the proxy server may be configured to store one or more scripts in a computer-accessible medium, for example a file server, RAID (Redundant Array of Independent Disks), or hard disk. The proxy server may access stored scripts as indicated by script requests received from one or more clients.

In one embodiment, the proxy server may parse and potentially modify the sequence of server requests of an indicated script. For example, the sequence of server requests may include one or more HTTP requests, and the proxy server may parse the one or more HTTP requests and modify header information included in each of the one or more HTTP requests.

The proxy server may execute a script by sending a sequence of server requests to one or more of the servers. In one embodiment the sequence of server requests may be configured to traverse one or more pages of content hosted by the one or more servers. In one embodiment, the proxy server may receive one or more responses to the sequence of server requests from the one or more servers. In one embodiment, the proxy server may keep track of state (e.g. cookies).

The proxy server may generate an endpoint content from the one or more responses. In one embodiment, the endpoint content may include an endpoint page of content culminating from the traversal of the one or more pages of content. The proxy server may provide the endpoint content to the client that sent the script request. The client that sent the script request may transparently interact from the endpoint content with the one or more servers. For example, the endpoint content may include a web page and the client may include a web browser. The proxy server, by traversing one or more intermediate web pages, may redirect the web browser to a destination web page thus transparently performing the repetitive task of traversing the intermediate web pages for the client.

In one embodiment, the proxy server may be configured to monitor interaction between a client and one or more of the servers, and generate a script to perform the monitored interaction. In one embodiment, the proxy server may store the generated script. The proxy server may access the stored script in response to a script request from a client. In one embodiment, a client may manually create and modify existing scripts.

In one embodiment, the proxy server may receive a server request that is not a script request from a client. The proxy server may be configured to pass the server request to one of the servers. The proxy server may receive a response to the server request from the server. The proxy server may be further configured to pass the response to the client that sent the server request.

### BRIEF DESCRIPTION OF THE DRAWINGS

FIG. 1 illustrates a client-server system with a scriptable proxy server, according to one embodiment;

FIG. 2 illustrates one embodiment of a scriptable proxy server;

FIG. 3 illustrates a script generator and a script store, according to one embodiment;

FIG. 4 is a flowchart of a method of performing a script in response to a script request, according to one embodiment;

FIG. 5 illustrates an embodiment of generating scripts from monitored interactions between one or more clients and one or more servers;

FIGS. 6A-6D illustrate embodiments of interactions among a client, a scriptable proxy server and a server; and

FIG. 7 illustrates one embodiment of performing a sequence of server requests.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS OF THE INVENTION

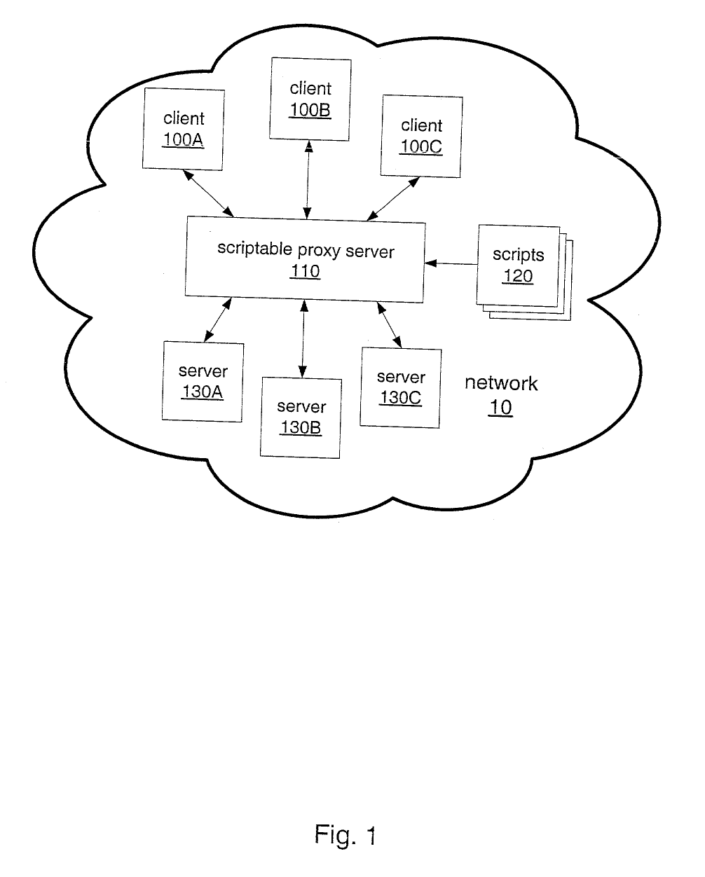

FIG. 1 illustrates a client-server system with a scriptable proxy server according to one embodiment. Scriptable proxy server 110 may be coupled to clients 100 and servers 130 via network 10. Network 10 may be a wired or wireless network or a combination thereof, and may include a LAN (Local Area Network), WAN (Wide Area Network), Internet, or a combination thereof. Any of a variety of one or more networking protocols may be used in network 10, for example, TCP/IP (Transmission Control Protocol/Internet Protocol) and/or HTTP (Hyper Text Transport Protocol). Clients 100 may be any of a variation of devices such as desktop personal computers, notebook computers, personal digital assistants, mobile phones and point-of-sale terminals running client applications such as web browsers. Servers 130 may be, for example, web servers, application servers and/or HTTP (Hyper Text Transport Protocol) servers. In some embodiments, scripts 120 may be stored, for example, in a computer-accessible medium, for example, a file server, RAID (Redundant Array of Independent Disks), or hard disk, available to scriptable proxy server 110.

Clients 100 may be configured to send script requests. For example, a script request may be indicated within a communication from a client browser application. Each script request may indicate a particular script 120. For example, Scriptable proxy server 110 may receive client communications for one or more of servers 130. If the client communication includes a script request, scriptable proxy server 110 may execute a script 120, indicated by the script request. Proxy server 110 may interact with one or more servers 130 as specified in the script 120 and return a script result to the requesting client.

Each script 120 may include a sequence of server requests. Server requests may include, but are not limited to, requests for data or commands. In one embodiment, the sequence of server requests may include one or more HTTP requests. In one embodiment, each of the scripts 120 may include one or more lines of code of an interpreted language (e.g. Perl or Python).

In one embodiment, scripts 120 may include looping that iterates over one or more server requests. For example, a script 120 may include looping code to submit a plurality of identical or similar queries to a server to retrieve a plurality of records. In one embodiment, scripts 120 may include conditional branching to select from among a plurality of branches of server requests if one or more particular conditions are met. For example, a script 120 may be executable to issue a server request for a value. The server may, in response to the server request, send the value to scriptable proxy server 110. If the value is over a predetermined value specified by the script 120, the script 120 may be executable to issue one or more server requests. If the value is not over the predetermined value specified by the script, the script 120 may be executable to issue one or more other server requests. In other embodiments, scripts 120 may include high-level scripting constructs such as statements directing control flow.

In one embodiment, a developer may write scripts 120 for testing a web application. In one embodiment, scripts 120 may be used to automate traversal of a web site for a user. For example, the user may frequently and/or periodically desire to traverse to a destination web site, and scriptable proxy server 110 may execute a script 120 to transparently traverse one or more intermediate web sites or pages to reach the destination web site or page. The following is an exemplary script written in the Python programming language and is not intended to be limiting:

# test.py

root=http://habanero:8080/examples/jsp/sessions/

queue=RequestQueue ( )

queue.add(Request (root+“carts.html”))

queue.add(Request (root+“cartsjsp?item=JSP+Book&submit=add”))

queue.add( Request (root +“cartsjsp?item=Twin+peaks+tapes&submit=add”))

queue.execute (source)

In one embodiment, scriptable proxy server 110 may receive a script request from a client 100. The script request may indicate a particular script 120. Scriptable proxy server 110 may execute the script 120. In one embodiment, to execute the script 120, scriptable proxy server 110 may send a sequence of server requests of the script 120 to one or more servers 130. In one embodiment, scriptable proxy server 110 may parse and modify the sequence of server requests and send the modified sequence of server requests to one or more servers 130. The sequence of server requests may be configured to traverse one or more pages of content (e.g. web pages) hosted by the one or more servers 130. The script may include or may indicate a source for any data or other input to be supplied to a server 130 for each intermediate page. The one or more servers 130 may respond to the sequence of server requests by sending scriptable proxy server 110 content culminating in an endpoint content, e.g. a destination web page. Scriptable proxy server 110 may provide the endpoint content to the client 100 that sent the script request. The client 100 may then interact from the endpoint content with the one or more servers 130. For example, the endpoint content may include a web page and the client 100 may include a web browser.

In response to a script request from a client web browser, scriptable proxy server 110, by traversing one or more intermediate web pages, may redirect the client web browser to a destination web page thus transparently performing a complex or tedious task of traversing the intermediate web pages for the client. In one embodiment, scriptable proxy server 110 may keep track of state. For example, in one embodiment, scriptable proxy server 110 may store cookies received from the one or more servers 130.

In one embodiment, a client 100 may send a communication or server request that is not a script request. Scriptable proxy server 110 may transparently pass such server requests not including script requests on to the server 130. The server 130 may send a response to the server request to the client 100 that sent the server request. Scriptable proxy server 110 may transparently pass the response from the server 130 to the client 100 that sent the server request or the server may respond directly to the client.

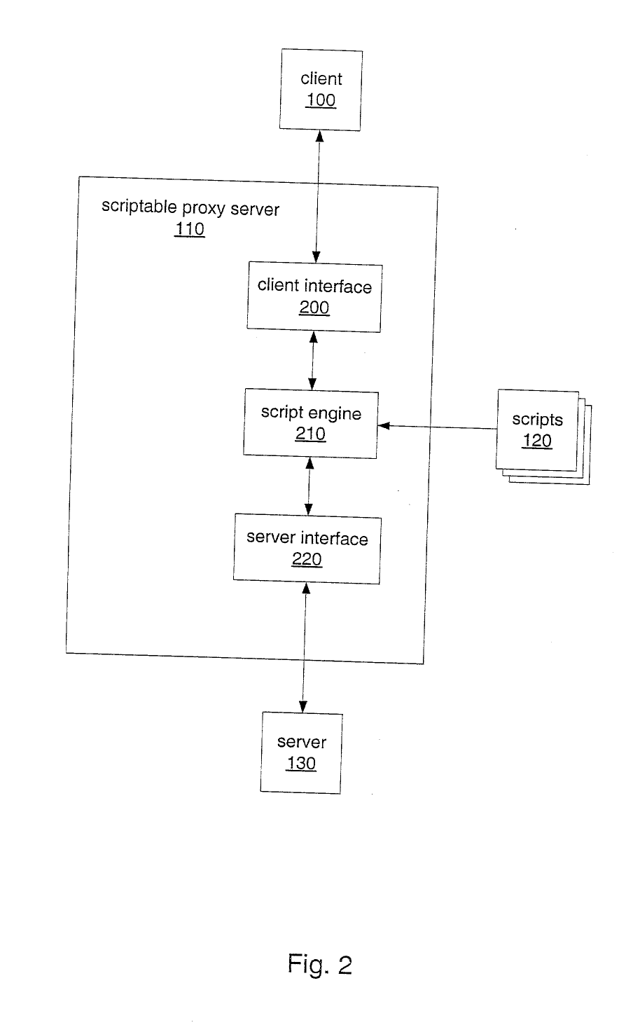

FIG. 2 illustrates one embodiment of a scriptable proxy server. Scriptable proxy server 110 may interface with one or more clients 100 via client interface 200. The client interface 200 may be configured to receive client communications for one or more servers or destinations (e.g. as indicated in a URL). Scriptable proxy server 110 may interface with a server 130 via server interface 220. Scriptable proxy server 110 may have access to a computer-accessible medium (e.g. a file server, a RAID, a hard disk, etc.) storing one or more scripts 120. A script engine 210 may be coupled to the client and server interfaces to execute requested scripts. The scriptable proxy server may include a processor and memory storing program instructions executable by the processor to implement the client interface 200, script engine 210 and server interface 220.

In one embodiment, client interface 200 may transparently monitor communications between client 100 and server 130. Client 100 and/or server 130 may interact with each other without being aware of the monitoring. Client interface 200 may receive a communication including a script request from client 100. The script request may indicate a particular script 120.

In one embodiment, client interface 200 may notify script engine 210 in response to the script request. Script engine 210 may access the script 120 as indicated by the script request. Script engine 210 may generate a sequence of server requests (e.g. a sequence of HTTP requests) in accordance with the indicated script 120. Script engine 210 may provide the sequence of server requests to server interface 220. Server interface 220 may send the sequence of server requests to server 130. The sequence of server requests may be configured to traverse one or more pages of content hosted by server 130 culminating in an endpoint content (e.g. a web page and/or results from one or more queries). Server 130 may provide the endpoint content to proxy server 110 through server interface 220. The proxy server 110 may return the endpoint content to client 100 through client interface 200. In one embodiment, client 100 may then interact from the endpoint content with server 130. For example, the endpoint content may include a web page and client 100 may include a web browser. In one embodiment, a developer may use the web browser to test the web page or a user may use the web browser to interact with the web page to access other content hosted by server 130.

Client interface 200 may receive a server request that is not a script request from client 100. In one embodiment, client interface 200 may be configured to pass the server request to server interface 220. Server interface 220 may transparently send the server request to server 130. Server interface 220 may receive a response to the server request from server 130 and the response may transparently sent through client interface 200 to the client 100.

Scriptable proxy server 110 may be implemented as a separate network entity. In other embodiments, scriptable proxy server 110 may be implemented as part of a web site. For example, scriptable proxy server 110 may be part of the front end of a web site such that all requests to the web site's URL pass through the scriptable proxy server. In other embodiments, the functionality of the scriptable proxy server 110 may be built into one or more content servers. In yet other embodiments, the functionality of the scriptable proxy server 110 may be included with one or more clients.

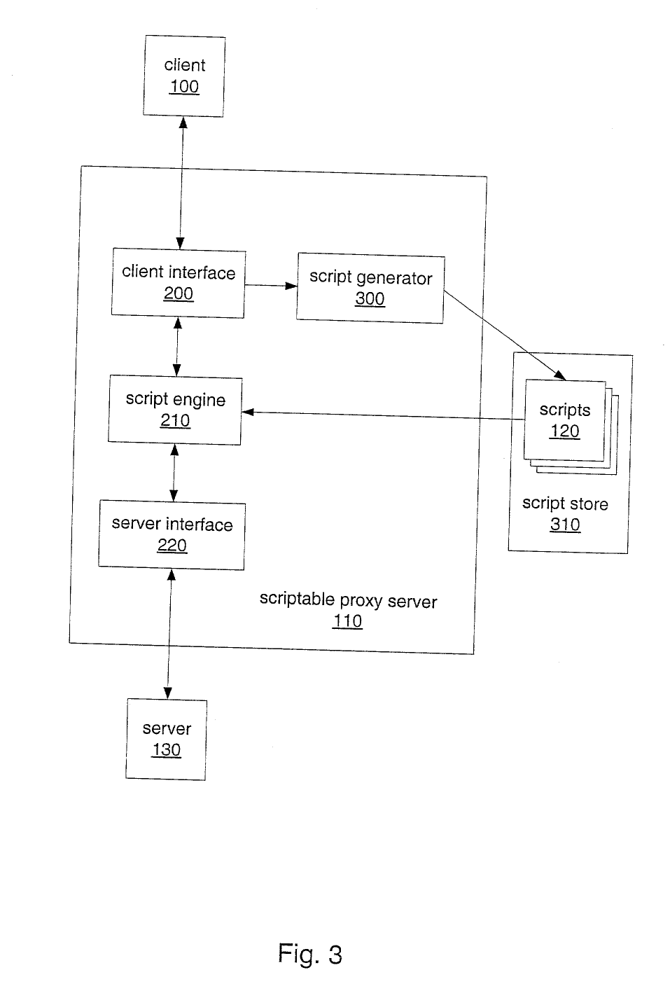

FIG. 3 illustrates a script generator and a script store, according to one embodiment. Scriptable proxy server 110 may include script generator 300 and have access to script store 310. Script generator 300 may be configured to monitor interactions between client 100 and server 130. Script generator 300 may be configured to generate a script 120 from the monitored interactions. In one embodiment, script generator 300 may generate the script 120 in response to one or more requests from client 100. For example, a communication from a client browser may indicate to start recording interactions between the client browser and a server(s) to create a script. At the desired endpoint, the client may send a request to stop script recording. From the recorded sequence of interactions, script generator 300 may generate and store a script. The generated script may be referenced by an ID (e.g. supplied by the client) so that the client may later request execution of the script.

Script generator 300 may store the script 120 to script store 310. Script store 310 may be included in a computer-accessible medium (e.g. a networked hard disk, a file server system, or a RAID system). Script engine 210 may retrieve the generated script 120 from script store 310 in response to a script request indicating the generated script 120 from client 100 and execute the generated script 120. In one embodiment, a user may create (e.g. offline) a script and store the created script in script store 310. In one embodiment, the user may edit scripts 120.

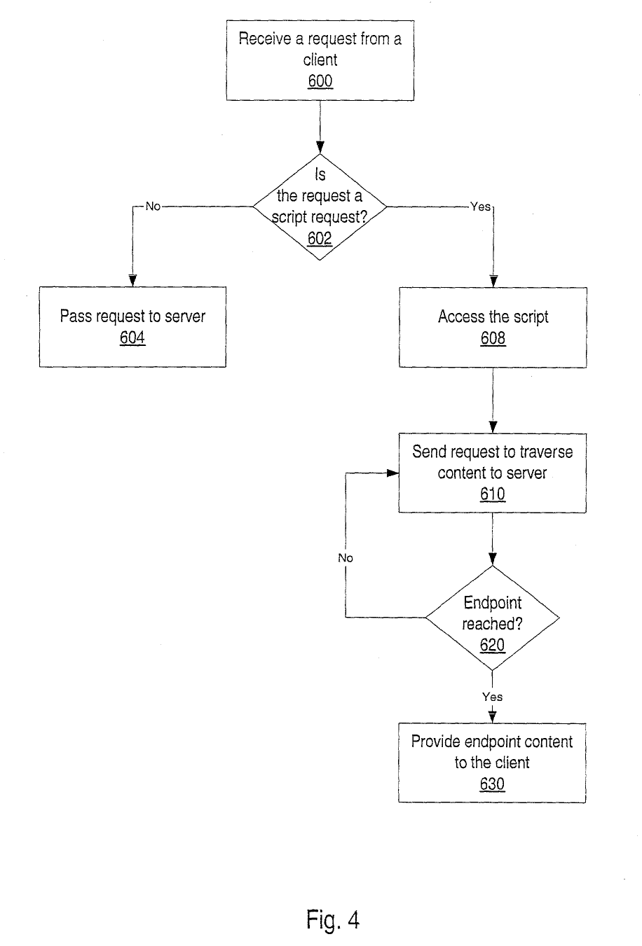

FIG. 4 is a flowchart of a method of executing a script in response to a script request according to one embodiment. A scriptable proxy server may receive a request from a client as indicated at 600. The proxy server may examine the request to determine if the request is a script request as indicated at 602. If the request is not a script request, the request may be passed to the server that is the target of the request as indicated at 604. If the request is a script request, the scriptable proxy server may access a script as indicated at 608. In one embodiment, the proxy server may access the script indicated by the script request from a script store accessible by the proxy server. In one embodiment, the script may be comprised in the script request or otherwise provided by the client. The scriptable proxy server may execute the accessed script by generating a sequence of server requests using the script and sending the sequence of server requests to one or more servers as indicated at 610. In one embodiment, the scriptable proxy server may parse and modify the sequence of server requests. For example, the sequence of server requests may include HTTP requests, and the proxy server may parse and modify one or more HTTP headers of the HTTP requests. The scriptable proxy server may send the modified sequence of server requests to the one or more servers. The sequence of server requests may be configured to traverse one or more pages of content hosted by the servers. The sequence of server requests may be sent one or more at a time in an iterative manner as indicated at 620.

Traversing the pages of content may culminate in an endpoint content. The endpoint content may include a web page and/or results from one or more queries. The one or more servers may provide the endpoint content to the scriptable proxy server in response to the sequence of server requests. The scriptable proxy server may provide the endpoint content to the client that sent the script request as indicated at 630. For example, the client may include a web browser, the endpoint content may include a web page, and the scriptable proxy server may redirect the web browser to the web page. In one embodiment, the client may interact from the endpoint content with the one or more servers.

Note that the method described in FIG. 4 is merely an example. The method may be implemented in software, hardware, or a combination thereof. The order of method may be changed, and various elements may be added, reordered, combined, omitted, modified, etc.

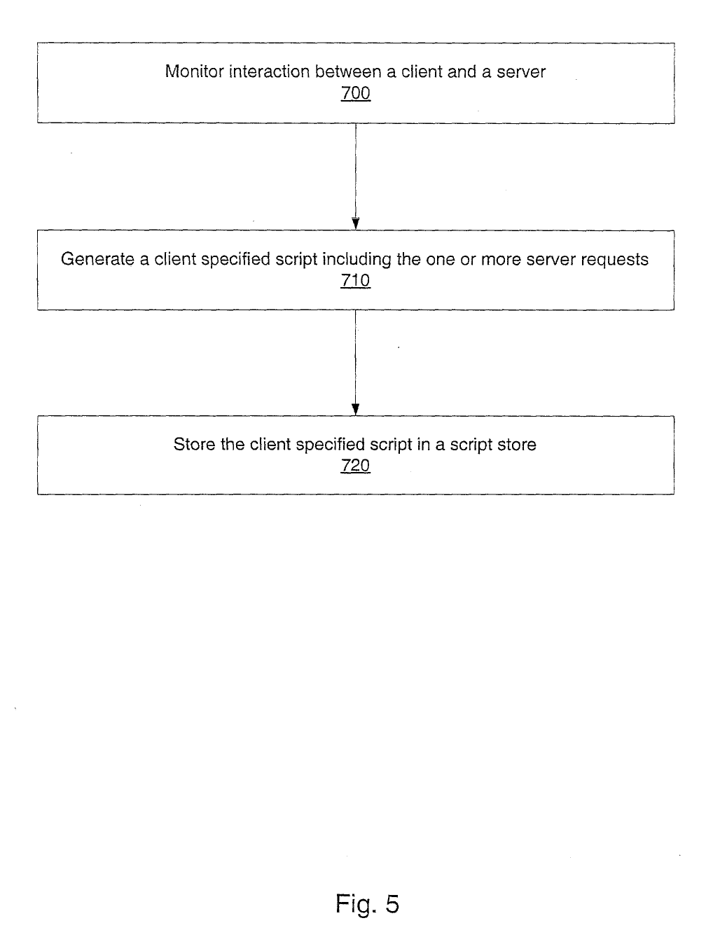

FIG. 5 illustrates an embodiment of generating scripts from monitored interactions between one or more clients and one or more servers. In one embodiment, a scriptable proxy server may pass server requests from a client to one or more servers. The scriptable proxy server may pass responses from the one or more servers to the client. The scriptable proxy server may monitor interactions between the clients and the one or more servers as indicated at 700. In one embodiment, for example, the scriptable proxy server may cache information on server requests that the client sends to the one or more servers. From the monitored interactions, the scriptable proxy server may generate a script as indicated at 710. In one embodiment, the script may be generated in response to a request from the client. In one embodiment, the scriptable proxy server may store the generated script, for example, to a storage device such as a file server, a RAID, or a hard disk as indicated at 720.

Note that the method described in FIG. 5 is merely an example. The method may be implemented in software, hardware, or a combination thereof. The order of method may be changed, and various elements may be added, reordered, combined, omitted, modified, etc.

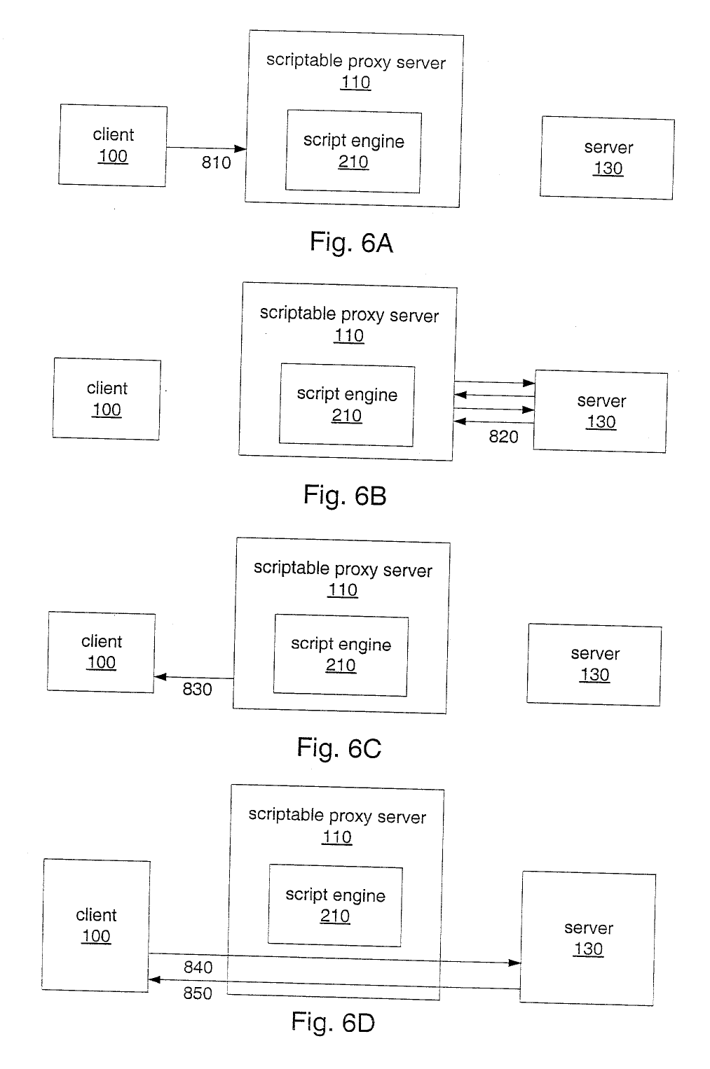

FIGS. 6A-6D illustrate embodiments of interactions among a client, a scriptable proxy server, and a server. In FIG. 6A, scriptable proxy server 110 may receive a script request from client 100 as indicated at 810. Scriptable proxy server 110 may include script engine 210. In some embodiments, script engine 210 may include one or more modules for accessing, parsing, modifying, and/or executing scripts. Script engine 210 may respond to the script request by retrieving a script indicated by the script request and generating a sequence of server requests from the indicated script.

Script engine 210 may execute the indicated script by sending the sequence of server requests to server 130 as illustrated in FIG. 6B. Server 130 may receive the sequence of server requests and may respond, for example, by sending content to scriptable proxy server 110, as indicated at 820. In one embodiment, the sequence of server requests may be configured to traverse one or more pages of content (e.g. web pages) hosted by server 130. Scriptable proxy server 110 may generate an endpoint content (e.g. a web page) from the one or more pages of content. Scriptable proxy server 110 may provide the endpoint content to client 100 as indicated at 830 in FIG. 6C.

Client 100 may interact from the endpoint content with server 130 as illustrated in FIG. 6D. Scriptable proxy server 110 may pass one or more server requests that are not script requests from client 100 to server 130 as indicated at 840. Server 130 may respond to the one or more server requests by sending client 100 one or more server request responses. Scriptable proxy server 110 may pass the one or more server request responses from server 130 to client 100 as indicated at 850.

For example, in one embodiment, the script may automate testing a web application for a developer. The developer may use the client (e.g. web browser) and the endpoint content for testing. As another example, the script may automate the traversal of web sites for a user. The user may interact with the desired destination included within the endpoint content.

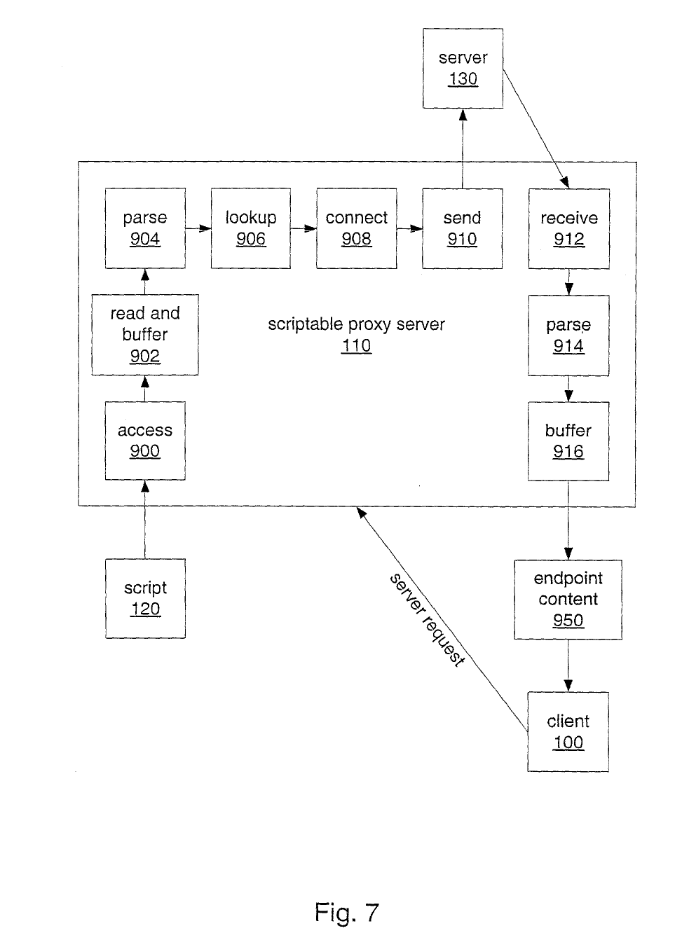

FIG. 7 illustrates one embodiment of performing a sequence of server requests. Scriptable proxy server 110 may receive a script request from client 100. The script request may indicate a script 120. In one embodiment, script 120 may be accessed from a computer-readable medium (e.g. a file server, a RAID, a hard disk, etc.) that may store script 120 as indicated at 900. In one embodiment, one or more server requests according to the requested script may be read and buffered as indicated at 902. The one or more server requests may be parsed as indicated at 904. Each of the one or more server requests may indicate a particular server, in this example server 130. As indicated at 906, a lookup (e.g. a DNS lookup) may be performed to locate server 130 as indicated by the one or more server requests. A connection(s) (e.g. to a socket interface) may be opened to server(s) 130 as indicated at 908. The one or more server requests may be sent to server 130 as indicated at 910. Content generated in response to the one or more server requests may be received from server 130 as indicated at 912. The content may be parsed as indicated at 914. The content may be buffered as indicated at 916. This process is repeated until the script is completed. Upon completion of the server requests according to the script, endpoint content 950 may be provided to client 100. For example, client 100 may include a web browser and endpoint content 950 may include a web page to which the web browser is redirected in accordance with endpoint content 950.

In one embodiment, scriptable proxy server 110 may execute script 120 using a thread. The thread may pause execution until data is available for sending and/or reading data from script 120, one or more servers, and/or client 100 (e.g. multiplexed input/output via a system level select or poll service). In other embodiments, scriptable proxy server 110 may use a plurality of threads and/or processes in any of various blocked or unblocked input/output schemes.

Note that the method described in FIG. 7 is merely an example. The method may be implemented in software, hardware, or a combination thereof. The order of method may be changed, and various elements may be added, reordered, combined, omitted, modified, etc.

Various embodiments may further include receiving, sending or storing instructions and/or data implemented in accordance with the foregoing description upon a computer-accessible medium or article of manufacture. Generally speaking, a computer-accessible medium or article of manufacture may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system comprising:
a server;
a client device; and
a proxy server, wherein the proxy server is configured to:
receive a script request from the client device, wherein the script request indicates a script, wherein the script comprises one or more server requests;
send the one or more server requests to the server in response to the script request;
receive an endpoint content from the server in response to the one or more server requests; and
provide the endpoint content to the client device.

2. The system as recited in claim 1, wherein the proxy server is further configured to parse the one or more server requests of the indicated script prior to sending the one or more server request to the server.

3. The system as recited in claim 1, wherein the one or more server requests are in an ordered sequence, and wherein, to send the one or more server requests, the proxy server is further configured to send the sequence of server requests to the server in the ordered sequence.

4. The system as recited in claim 1, wherein, to receive an endpoint content, the proxy server is further configured to receive content from the server in response to each of the one or more server requests culminating in the endpoint content.

5. The system as recited in claim 1, wherein the proxy server is further configured to:
receive a server request from the client device; and
send the server request to the server.

6. The system as recited in claim 5, wherein the proxy server is further configured to:
receive a response to the server request from the server; and
send the response to the client device.

7. The system as recited in claim 1, wherein the client device is configured to interact from the endpoint content with the server.

8. The system as recited in claim 1, wherein the one or more server requests comprise one or more HTTP requests.

9. The system as recited in claim 1, wherein the client device comprises a web browser, wherein the one or more server requests are configured to traverse one or more web pages of the server culminating in the endpoint content, wherein the endpoint content comprises a destination web page, and wherein the web browser is configured to interact with the other web page.

10. The system as recited in claim 1, wherein the proxy server is further configured to:
store one or more scripts in the script store; and
access the indicated script from the script store.

11. The system as recited in claim 1, wherein the proxy server is further configured to:
monitor interaction between the client device and the server, wherein the monitored interaction comprises a plurality of server requests;
generate the script from the plurality of server requests; and
store the script in a script store.

12. A proxy server comprising:
a processor;
memory configured to store program instructions, wherein the program instructions are executable by the processor to:
receive a script request from a client device, wherein the script request indicates a script comprising one or more server requests;
send the one or more server requests of the script to a server;
receive one or more pages of content;
receive an endpoint content; and
provide the endpoint content to the client device.

13. The proxy server as recited in claim 12, wherein the program instructions are further executable to:
receive a server request from the client device;
send the request to the server;
receive a response to the server request from the server; and
send the response to the client device.

14. The proxy server as recited in claim 12, wherein the program instructions are further executable to:
monitor interaction between the client device and the server;
generate the script from one or more server requests sent from the client device to the server, wherein the script is executable to perform the monitored interaction; and
store the generated script to a storage medium.

15. A proxy server comprising:
means for receiving a script request from a client device, wherein the script request indicates a script comprising one or more server requests for a server;
means for executing the indicated script to traverse a series of content to reach a final content; and
means for providing the final content to the client device.

16. The proxy server as recited in claim 15, further comprising:
means for storing one or more scripts to a storage medium; and
means for retrieving the indicated script from the storage medium.

17. The proxy server as recited in claim 15, wherein the series of content comprises a series of web pages, and wherein the final content comprises a final web page.

18. The proxy server as recited in claim 15, further comprising means for generating a script from interactions between the client device and one or more servers.

19. A method comprising:
receiving a script request from a client device, wherein the script request indicates a script comprising sequence of server requests for a server;
sending the sequence of server requests to the server;
receiving a sequence of content pages in response to the sequence of server requests from the server; and
providing a final content page to the client device.

20. The method as recited in claim 19, further comprising:
receiving a server request from the client device;
sending the request to the server;
receiving a response to the server request from the server; and
sending the response to the client device.

21. The method as recited in claim 19, further comprising:
generating a client-specified script in response to a script generation request, wherein the client-specified script to perform specified interaction with the server; and
storing the client specified script.

22. The method as recited in claim 21, wherein generating the client-specified script comprises obtaining the specified interaction by monitoring interaction between the client and the server.

23. The method as recited in claim 21, wherein generating the client-specified script comprises the client providing the specified interaction.

24. The method as recited in claim 21, further comprising:
retrieving the client specified script; and
executing the client specified script.

25. An article of manufacture comprising software instructions executable to implement:
receiving a script request from a client device, wherein the script request indicates a script comprising sequence of server requests for a server;
sending the sequence of server requests to the server;
receiving a sequence of content pages in response to the sequence of server requests from the server; and
providing a final content page to the client device.

26. The article of manufacture as recited in claim 25, wherein the program instructions are further executable to implement:
receiving a server request from the client device;
sending the request to the server;
receiving a response to the server request from the server; and
sending the response to the client device.

27. The article of manufacture as recited in claim 25, wherein the program instructions are further executable to implement:
generating a client-specified script in response to a script generation request, wherein the client-specified script to perform specified interaction with the server; and
storing the client specified script.

28. The article of manufacture as recited in claim 27, wherein generating the client-specified script comprises obtaining the specified interaction by monitoring interaction between the client and the server.

29. The article of manufacture as recited in claim 27, wherein generating the client-specified script comprises the client providing the specified interaction.

30. The article of manufacture as recited in claim 27, wherein the program instructions are further executable to implement:
retrieving the client specified script; and
executing the client specified script.
